(19) United States
(12) Patent Application Publication
(10) Pub. No.: US 2026/0301134 A1
(43) Pub. Date: Oct. 1, 2026

(54) ADAPTIVE THREE-DIMENSIONAL (3D) DENOISING OF POSITRON EMISSION TOMOGRAPHY (PET) IMAGES

(71) Applicant: University of Florida Research Foundation, Incorporated, Gainesville, FL (US)

(72) Inventors: Kuang Gong, Gainesville, FL (US); Boxiao Yu, Gainesville, FL (US)

(21) Appl. No.: 19/629,733

(22) Filed: Mar. 26, 2026

Related U.S. Application Data
(60) Provisional application No. 63/781,654, filed on Apr. 1, 2025.

(51) Int. Cl. G06T 5/70; G06T 5/60; G06T 12/20

(52) U.S. Cl. CPC G06T 5/70; G06T 5/60; G06T 12/20; G06T 2207/10104; G06T 2207/20081; G06T 2207/20084; G06T 2207/30004; G06T 2210/41; G06T 2211/441; G06T 2211/444

(57) ABSTRACT

A method for denoising low-dose positron emission tomography (PET) images comprising providing a low-dose PET image to a pretrained vision-language model to receive a dose embedding and an anatomy embedding sequence; generating a modified time step embedding by mapping the dose embedding into a timestep embedding; generating a feature map embedding sequence based on the modified time step embedding and an input feature map; providing the feature map embedding sequence and the anatomy embedding sequence to a cross-attention block of a transformer model to receive a cross-attention output; generating an output feature map based on the cross-attention output and the feature map embedding sequence; and providing an input image to a diffusion model to receive a reconstructed image based on the output feature map.

### CROSS REFERENCE TO RELATED APPLICATION

This application claims the priority of U.S. Provisional Application No. 63/781,654, entitled “ADAPTIVE THREE-DIMENSIONAL (3D) DENOISING OF POSITRON EMISSION TOMOGRAPHY (PET) IMAGES,” filed on Apr. 1, 2025, the disclosure of which is hereby incorporated by reference in its entirety.

### GOVERNMENT SUPPORT

This invention was made with government support under Grant No(s). R01 EB034692 and R01 AG078250, awarded by the National Institutes of Health. The government has certain rights in the invention.

### BACKGROUND

Positron emission tomography (PET) provides an imaging modality that is widely used in clinical diagnosis and preclinical research of diseases, such as cancer, neurodegenerative diseases, and cardiac diseases, due to its high sensitivity and precise quantification capabilities. Due to concerns regarding radiation exposure and/or potential cancer risk, PET injection dose or scanning time may be reduced. However, such reductions lead to a deterioration of PET image quality with respect to quantitative accuracy and lesion detectability. That is, due to various physical degradation factors and limited photon counts detected, restrictions in image resolution and signal-to-noise ratio prevent the attainment of high-quality images from low-dose PET scans. Accordingly, enhancing PET image quality to maintain its quantitative accuracy and lesion detectability at both normal-dose and low-dose scenarios is desirable.

### BRIEF SUMMARY

Various embodiments described herein relate to methods, apparatus, systems, computing devices, computing entities, and/or the like for denoising low-dose positron emission tomography (PET) images.

According to some embodiments, the method comprises providing a low-dose positron emission tomography (PET) image to a pretrained vision-language model to receive a dose embedding and an anatomy embedding sequence, wherein the dose embedding semantically corresponds to a dose text prompt and the anatomy embedding sequence semantically corresponds to an anatomical text prompt; generating a modified time step embedding by mapping the dose embedding into a timestep embedding; generating a feature map embedding sequence based on the modified time step embedding and an input feature map; providing the feature map embedding sequence and the anatomy embedding sequence to a cross-attention block of a transformer model to receive a cross-attention output; generating an output feature map based on the cross-attention output and the feature map embedding sequence; and providing an input image to a diffusion model to receive a reconstructed image based on the output feature map.

In some embodiments, the method further comprises determining, using the cross-attention block, a query based on the feature map embedding sequence and a query learnable projection; determining, using the cross-attention block, a value based on the anatomy embedding sequence and a value learnable projection; and determining, using the cross-attention block, a key based on the anatomy embedding sequence and a key learnable projection. In some embodiments, the cross-attention block is inserted at a neural network resolution of the diffusion model. In some embodiments, the method further comprises providing a set of one or more training images, including the low-dose PET image, to an image controller to receive a dose image embedding; providing the set of one or more training images, including the low-dose PET image, to an image encoder of the pretrained vision-language model to receive an anatomy image embedding; providing the dose text prompt to a text encoder of the pretrained vision-language model to receive a dose text embedding; and providing the anatomical text prompt to the text encoder of the pretrained vision-language model to receive an anatomy text embedding. In some embodiments, the method further comprises generating a dose image-to-text loss or a dose text-to-image loss based on a first cosine similarity value between the dose image embedding and the dose text embedding; and generating an anatomy image-to-text loss or an anatomy text-to-image loss based on a second cosine similarity value between the anatomy image embedding and the anatomy text embedding. In some embodiments, generating the modified time step embedding further comprises generating a dose-conditioned text prompt based on the dose image embedding; and modifying the timestep embedding based on the dose-conditioned text prompt.

In some embodiments, the dose text prompt and the anatomical text prompt are associated with the low-dose PET image. In some embodiments, the timestep embedding corresponds to a conditional denoising diffusion probabilistic model (DDPM). In some embodiments, the method further comprises storing the output feature map in association with a neural network of the diffusion model; and generating, using the neural network, the reconstructed image. In some embodiments, (i) the diffusion model is configured to perform iterative denoising on the input image based on the output feature map, (ii) the diffusion model is trained on a dataset comprising a plurality of paired normal-dose and low-dose PET images, (iii) a normal-dose image of the plurality of paired normal-dose and low-dose PET images comprises a desired image quality, and (iv) a low-dose PET image of the plurality of paired normal-dose and low-dose PET images comprises a low image quality that is lower than the desired image quality.

According to some embodiments, a system comprises one or more processors and one or more non-transitory computer readable media storing processor-executable instructions that, when executed by the one or more processors, cause the one or more processors to perform operations comprising providing a low-dose positron emission tomography (PET) image to a pretrained vision-language model to receive a dose embedding and an anatomy embedding sequence, wherein the dose embedding semantically corresponds to a dose text prompt and the anatomy embedding sequence semantically corresponds to an anatomical text prompt; generating a modified time step embedding by mapping the dose embedding into a timestep embedding; generating a feature map embedding sequence based on the modified time step embedding and an input feature map; providing the feature map embedding sequence and the anatomy embedding sequence to a cross-attention block of a transformer model to receive a cross-attention output; generating an output feature map based on the cross-attention output and the feature map embedding sequence; and providing an input image to a diffusion model to receive a reconstructed image based on the output feature map.

In some embodiments, the operations further comprise determining, using the cross-attention block, a query based on the feature map embedding sequence and a query learnable projection; determining, using the cross-attention block, a value based on the anatomy embedding sequence and a value learnable projection; and determining, using the cross-attention block, a key based on the anatomy embedding sequence and a key learnable projection. In some embodiments, the cross-attention block is inserted at a neural network resolution of the diffusion model. In some embodiments, the operations further comprise providing a set of one or more training images, including the low-dose PET image, to an image controller to receive a dose image embedding; providing the set of one or more training images, including the low-dose PET image, to an image encoder of the pretrained vision-language model to receive an anatomy image embedding; providing the dose text prompt to a text encoder of the pretrained vision-language model to receive a dose text embedding; and providing the anatomical text prompt to the text encoder of the pretrained vision-language model to receive an anatomy text embedding. In some embodiments, the operations further comprise generating a dose image-to-text loss or a dose text-to-image loss based on a first cosine similarity value between the dose image embedding and the dose text embedding; and generating an anatomy image-to-text loss or an anatomy text-to-image loss based on a second cosine similarity value between the anatomy image embedding and the anatomy text embedding. In some embodiments, generating the modified time step embedding further comprises generating a dose-conditioned text prompt based on the dose image embedding; and modifying the timestep embedding based on the dose-conditioned text prompt. In some embodiments, the dose text prompt and the anatomical text prompt are associated with the low-dose PET image. In some embodiments, the timestep embedding corresponds to a conditional denoising diffusion probabilistic model (DDPM). In some embodiments, the operations further comprise storing the output feature map in association with a neural network of the diffusion model; and generating, using the neural network, the reconstructed image.

According to some embodiments, one or more non-transitory computer-readable storage media storing instructions that, when executed by one or more processors, cause the one or more processors to perform operations comprising providing a low-dose positron emission tomography (PET) image to a pretrained vision-language model to receive a dose embedding and an anatomy embedding sequence, wherein the dose embedding semantically corresponds to a dose text prompt and the anatomy embedding sequence semantically corresponds to an anatomical text prompt; generating a modified time step embedding by mapping the dose embedding into a timestep embedding; generating a feature map embedding sequence based on the modified time step embedding and an input feature map; providing the feature map embedding sequence and the anatomy embedding sequence to a cross-attention block of a transformer model to receive a cross-attention output; generating an output feature map based on the cross-attention output and the feature map embedding sequence; and providing an input image to a diffusion model to receive a reconstructed image based on the output feature map.

### BRIEF DESCRIPTION OF THE DRAWINGS

Embodiments incorporating teachings of the present disclosure are shown and described with respect to the figures presented herein.

FIG. 1 is an example overview of an architecture in accordance with some embodiments of the present disclosure.

FIG. 2 is an example computing entity in accordance with some embodiments of the present disclosure.

FIG. 3 is an example client computing entity in accordance with some embodiments of the present disclosure.

FIG. 4 is a dataflow diagram of an example 3D DDPM framework in accordance with some embodiments of the present disclosure.

FIG. 5 is an example architecture of a pre-trained model of a 3D DDPM framework in accordance with some embodiments of the present disclosure.

FIG. 6 is an example framework of a fine-tuned model of a 3D DDPM framework in accordance with some embodiments of the present disclosure.

FIG. 7 is a dataflow diagram of an example first training stage of a dose- and anatomy-aware DDPM PET denoising framework in accordance with some embodiments of the present disclosure.

FIG. 8 is a dataflow diagram of an example second training stage of a dose- and anatomy-aware DDPM PET denoising framework in accordance with some embodiments of the present disclosure.

FIG. 9 is a flowchart of an example process for denoising low-dose PET images according to some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides positron emission tomography (PET) image denoising for PET images (e.g., whole-body) based on a three-dimensional denoising diffusion probabilistic model (3D DDPM) that is able to handle variations in dose levels, scanners, and tracers. Denoising may be performed on PET images to enhance quantitative accuracy and lesion-detection precision. A challenge in PET image denoising is posed by significant variations of noise levels, dynamic ranges, and intensity distributions. Such variations may result from differences in scanner types, scanning start times, dose levels, scan durations, tracer types, organs of interest, patient weights, etc. Given that PET image quality is significantly affected by the aforementioned factors, a need exists for PET image denoising that is able to adapt to diverse clinical settings.

Leveraging extensive computational resources and large-scale medical imaging datasets, deep learning methods may be applied to image denoising. However, existing deep learning-based denoising methods face challenges in adapting to the variability of clinical settings, influenced by factors, such as scanner types, tracer choices, dose levels, and acquisition times. For example, existing convolutional neural network (CNN)-based methods may produce overly smooth results, which may overlook lesions or pathological changes. Furthermore, CNNs may directly map inputs to outputs through convolution operations, which lack flexibility in adapting to different acquisition protocols. In another example, generative adversarial networks (GANs) may denoise images with less spatial blurring and improved visual quality by adding adversarial loss. However, GANs also face challenges, such as unstable adversarial training and mode collapse.

Diffusion models may be used for various image processing tasks, such as denoising. A diffusion model may transform data from a normal distribution to a target data distribution through a gradual refinement process. In a forward diffusion process, Gaussian noise may be progressively added to target data until it approximates pure noise. In a reverse diffusion process, noise may be incrementally removed to reconstruct desired target data. However, existing diffusion model-based denoising methods face challenges in adapting to different acquisition protocols to accommodate diverse PET datasets effectively. For example, supervised learning-based methods may produce high-quality denoising results, but training a large-scale conditional diffusion model individually for a plurality of acquisition protocols may be impractical and inefficient. Moreover, paired data for specific protocols may be limited in scale. As such, directly fine-tuning large pre-trained diffusion models with limited data may lead to overfitting and catastrophic forgetting. Zero-shot methods may learn only the distribution of high-quality PET images during training and embed low-quality PET images as data-consistency constraints during inference to handle noisy images at various noise levels. While such an approach may obviate or reduce repeated training, it lacks the ability to convey fine-grained control over the final generated images, and denoising results may be highly sensitive to constraint strength. Thus, there is a need for PET image denoising methods that are able to incorporate target domain-specific information (such as particular PET protocols) in fine-tuning, while preserving the integrity of large pre-trained models.

According to various embodiments of the present disclosure, a method for PET image denoising is provided by employing a 3D DDPM comprising a 3D convolutional network to train a score function. In some embodiments, the 3D DDPM comprises a large diffusion model that operates in an original PET image space. In some embodiments, the 3D DDPM is pre-trained with a dataset of high-quality normal-dose PET images. In some embodiments, the 3D DDPM is fine-tuned on a smaller set of paired low- and normal-dose PET images, integrating low-dose inputs through a ControlNet architecture, thereby making the model adaptable to denoising tasks in diverse clinical settings. Accordingly, the fine-tuning may preserve precise local details, ensuring high-quality PET images suitable for clinical diagnosis.

In some embodiments, a two-stage whole-body PET image denoising framework leverages a large-scale pretrained vision-language model (VLM) to capture dose-aware and fine-grained anatomy-aware context, followed by a DDPM for adaptive denoising. In a first stage, dose and anatomical text prompts and low-dose PET image pairs may be utilized for dose- and anatomy-aware prior extraction with a VLM. For example, BiomedCLIP, a large-scale pretrained biomedical VLM, may be adopted, where weights of its original text encoder and image encoder may be frozen. To adapt the VLM to PET images, an image controller may be initialized from the VLM image encoder and fine-tuned using contrastive learning. The image controller may be trained to produce feature embeddings that align with corresponding text embeddings, enabling dose awareness and fine-grained anatomical context from low-dose PET images. In a second stage, the learned dose and anatomical embeddings may be incorporated into a DDPM denoising process through a prompt-learning module and cross-attention mechanisms, respectively. By doing so, conditioning is provided that enables adaptive denoising across different dose levels and anatomical regions. At inference, the dose and anatomical priors may be derived directly from the input low-dose PET to guide the diffusion denoising process, without additional metadata text inputs or accompanying computed tomography (CT) images.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random-access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

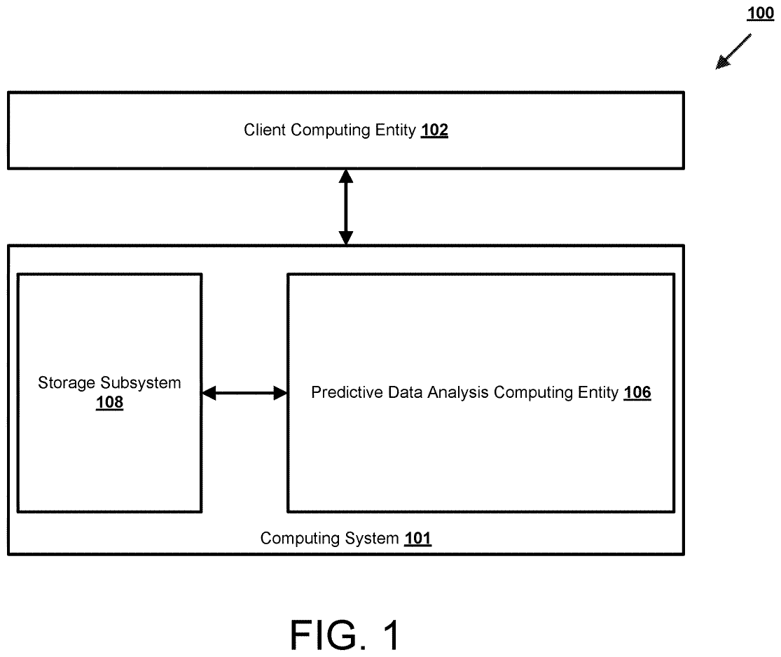

FIG. 1 is an example overview of an architecture 100 in accordance with some embodiments of the present disclosure. The architecture 100 includes a computing system 101 configured to receive image processing (e.g., PET image denoising) requests from client computing entity 102, process the image processing requests to generate processed images (e.g., denoised PET images), and provide the processed images to the client computing entity 102.

In some embodiments, computing system 101 may communicate with at least one of the client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include an image processing computing entity 106 and a storage subsystem 108. The image processing computing entity 106 may be configured to receive image processing (e.g., PET image denoising) requests from client computing entity 102, process the image processing requests to generate processed images (e.g., denoised PET images), and provide the processed images to the client computing entity 102.

The storage subsystem 108 may be configured to store input data used by the image processing computing entity 106 to perform image processing (e.g., PET image denoising). The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Example Data Analysis Computing Entity

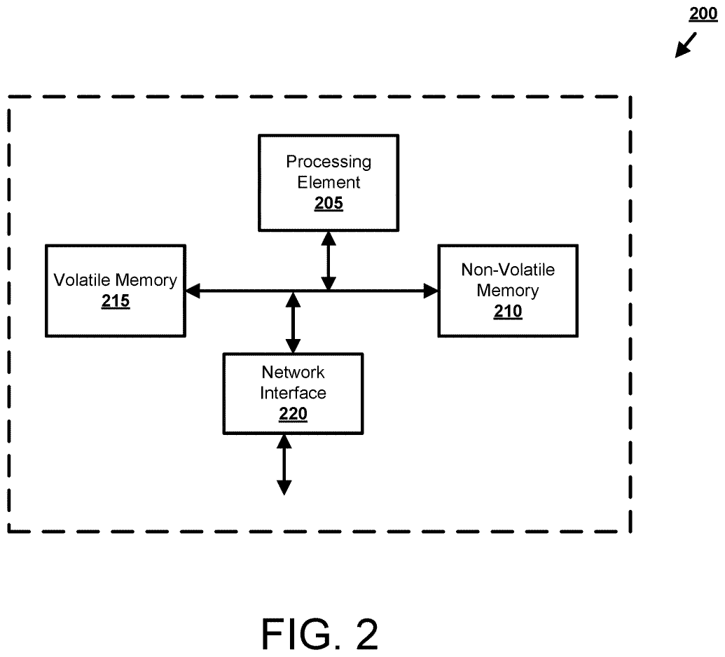

FIG. 2 is an example computing entity 200 in accordance with some embodiments of the present disclosure. The computing entity 200 is an example of the image processing computing entity 106. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In one embodiment, the computing entity 200 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing entity 200 may further include, or be in communication with, volatile media (also referred to as volatile storage, memory, memory storage, memory circuitry, and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing elements 205. Thus, the databases, database instances, database management systems, data, applications, programs, program modules, scripts, source code, object code, byte code, compiled code, interpreted code, machine code, executable instructions, and/or the like may be used to control certain aspects of the operation of the computing entity 200 with the assistance of the processing elements 205 and operating system.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 200 may be configured to communicate via wireless external communication networks using any of a variety of protocols, such as new radio (NR), general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### Example Client Computing Entity

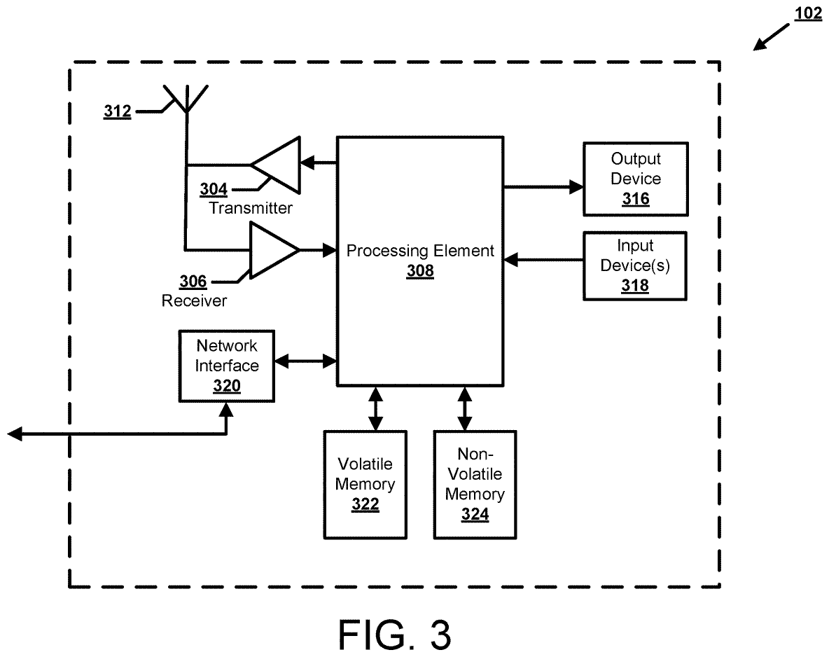

FIG. 3 is an example client computing entity 102 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In a particular embodiment, the client computing entity 102 may operate in accordance with multiple wireless communication standards and protocols, such as NR, GPRS, UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile storage or memory 322 and/or non-volatile storage or memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionality that are the same or similar to those of the computing entity 200, as described in greater detail above. As will be recognized, these architectures and descriptions are provided for exemplary purposes only and are not limited to the various embodiments.

In various embodiments, the client computing entity 102 may be embodied as an artificial intelligence (AI) computing entity. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example System Operations

Various embodiments of the present disclosure describe steps, operations, processes, methods, functions, and/or the like for enhancing the quality of low-dose whole-body PET images. In some embodiments, a 3D DDPM framework is configured to perform 3D PET image denoising. The 3D DDPM framework may utilize a diffusion process to learn (e.g., train a neural network) an underlying 3D PET data distribution from PET images and employ knowledge (e.g., using the trained neural network) gained from the learning to denoise low-quality PET images.

In some embodiments, a 3D DDPM framework comprises pre-training a neural network by gradually injecting noise into training data during a forward diffusion process to perturb the training data. The training data may comprise high-quality (e.g., normal-dose) PET images that are representative of images with a desirable amount of image quality (e.g., resolution). In some embodiments, normal-dose may refer to an effective radiation dosage (e.g., approximately 30 mSv) that may be applied to capture a PET image with a sufficiently high amount of resolution. In some embodiments, input data is provided to the 3D DDPM framework for conversion into denoised output data during a reverse diffusion process. For example, the denoised output data may comprise a denoised PET image that is representative of an enhanced (e.g., higher-resolution) PET image that is recovered from input data comprising noisy (e.g., low-dose) PET images. In some embodiments, low-dose may refer to a radiation dosage that is lower than, or a portion of, a normal-dose.

### Example Pre-Training of a 3D DDPM

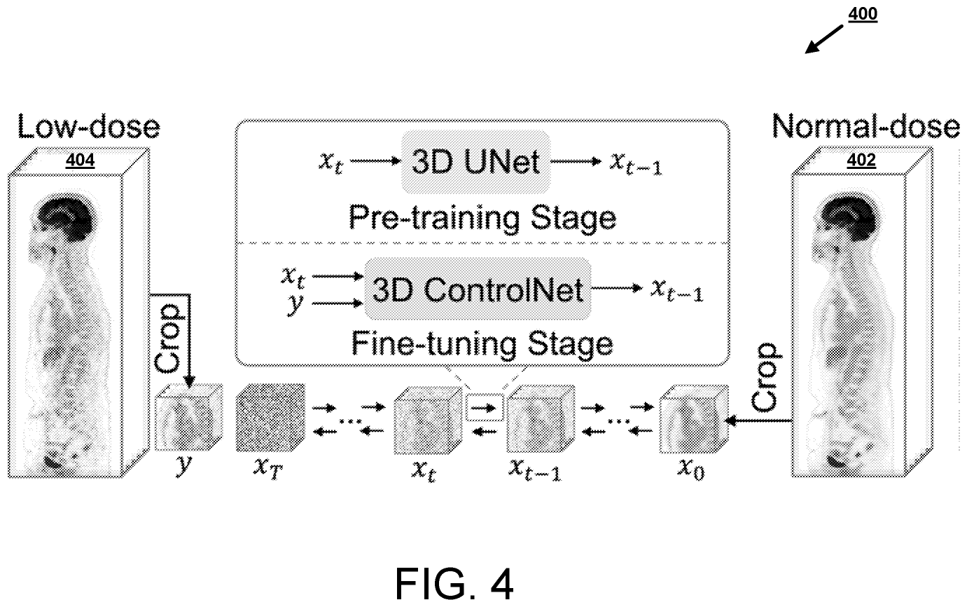

FIG. 4 is a dataflow diagram of an example 3D DDPM framework 400 in accordance with some embodiments of the present disclosure. The 3D DDPM framework 400 may comprise a forward diffusion process and a reverse diffusion process for pre-training a neural network (e.g., a CNN) to reconstruct normal-dose quality PET images from low-dose PET images.

A forward diffusion process of the 3D DDPM framework 400 may comprise sampling an image x₀ of a set of one or more high-quality normal-dose PET images 402 that is provided from a data distribution q(x). Gaussian noise may then be continuously added to x₀ over T time steps, following a predefined variance schedule

$${\{ {β}_{t} \}}_{t = 1}^{T}$$

where βₜ∈(0,1) is increased gradually. The forward diffusion process may be represented in the form of a Markov chain as

$$q ( {x}_{t} \vert {x}_{t - 1} ) = 𝒩 ( {x}_{t} ; \sqrt{1 - {β}_{t}} {x}_{t - 1} , {β}_{t} I ) \qquad Equation 1$$

By introducing αₜ=1−βₜ and

$${\overline{α}}_{t} = {\prod }_{s = 1}^{t} {α}_{s} ,$$

xₜ may be sampled at any time step from x₀, and as such, the forward diffusion process may be further expressed by:

$$q ( {x}_{t} \vert {x}_{0} ) = 𝒩 ( {x}_{t} ; \sqrt{{\overline{α}}_{t}} {x}_{0} , ( 1 - {\overline{α}}_{t} ) I ) \qquad Equation 2$$

The reverse diffusion process may comprise recovering a high-quality (e.g., denoised) PET image by progressively denoising sampled Gaussian noise. Given that a true reverse distribution q(xₜ₋₁|xₜ) is intractable, the 3D DDPM may comprise a neural network model p_{θ} with trainable parameters θ may be trained to approximate q(xₜ₋₁|xₜ) as

$${p}_{θ} ( {x}_{t - 1} \vert {x}_{t} ) = 𝒩 ( {x}_{t - 1} ; {μ}_{θ} ( {x}_{t} , t ) , {\sum }_{θ} ( {x}_{t} , t ) ) \qquad Equation 3$$

where μ_{θ} and Σ_{θ} may denote the predicted mean and variance, respectively, parameterized by a neural network with weights θ. The model p_{θ} may be re-parameterized to predict the noise ∈_{θ}(xₜ,t) instead of the mean. An update equation for estimating xₜ₋₁ at each time step using the score function ∈_{θ} may be determined by

$${x}_{t - 1} = \frac{1}{\sqrt{{α}_{t}}} ( {x}_{t} - \frac{{β}_{t}}{\sqrt{1 - {\overline{α}}_{t}}} {ϵ}_{θ} ( {x}_{t} , t ) ) + {σ}_{t} z , \qquad Equation 4$$

where z~ [symbol] (0, [symbol] ). In some embodiments, a modified CNN, such as UNet, may be used as the backbone network of the model p_{θ} to train the score function.

In some embodiments, the 3D DDPM is pre-trained using the set of one or more high-quality normal-dose PET images 402 to effectively learn a complex distribution of PET images. In some embodiments, pre-training the 3D DDPM comprises progressively adding and then removing noise through a Markov chain of diffusion steps, as disclosed above. Pre-training may enable the 3D DDPM to generalize well and provide a strong foundation model for subsequent fine-tuning steps. In some embodiments, the reverse diffusion process during pre-training is unconditional (i.e., not conditioned on low-dose PET images) and conditioning with a set of one or more low-dose PET images 404 provided during fine-tuning or inference.

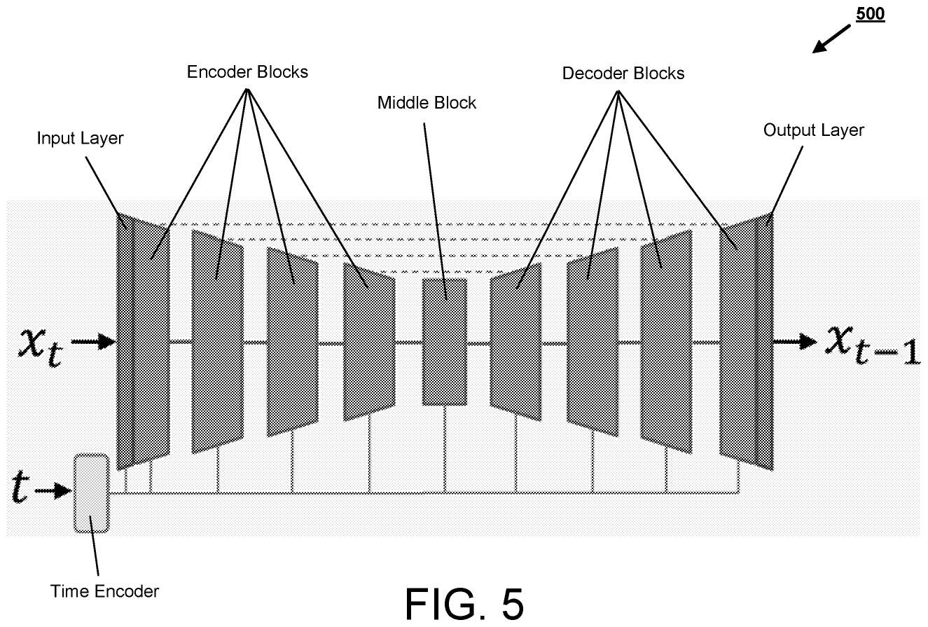

FIG. 5 is an example architecture of a pre-trained model 500 of a 3D DDPM framework in accordance with some embodiments of the present disclosure. The pre-trained model 500 comprises a pre-trained model that is based on a neural network with a CNN architecture, such as 3D UNet, for training a score function. By leveraging a large-scale dataset of high-quality PET images, the pre-trained 3D DDPM may effectively learn intricate features and variability inherent in PET imaging. Accordingly, pre-training may enable the pre-trained 3D DDPM to generalize well and provide a foundation model for subsequent fine-tuning steps.

### Example Fine-Tuning of a Pre-Trained 3D DDPM

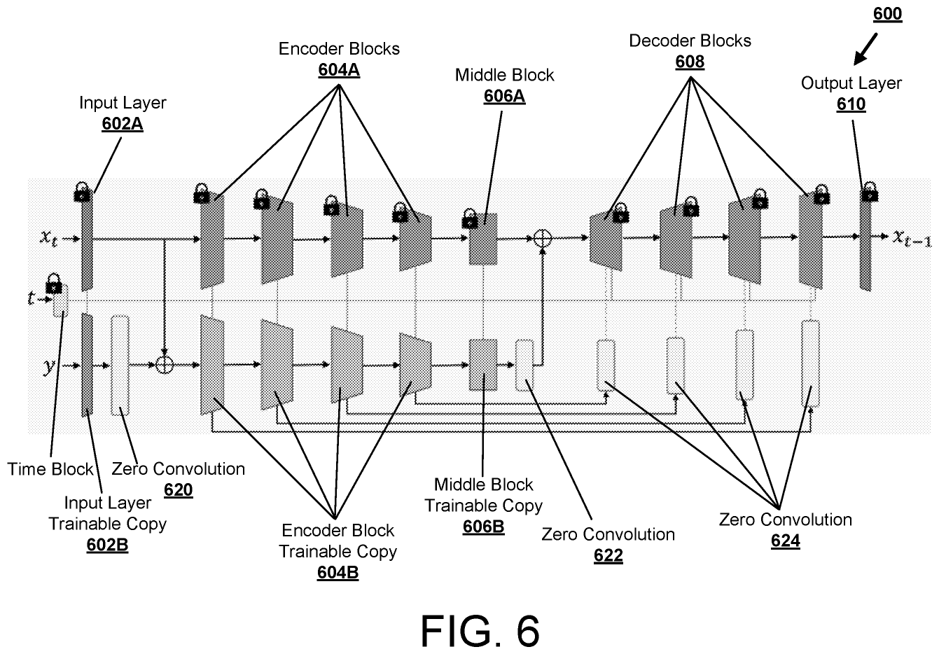

FIG. 6 is example framework of a fine-tuned model 600 of a 3D DDPM framework in accordance with some embodiments of the present disclosure. The fine-tuned model 600 comprises a pre-trained model (e.g., the pre-trained model 500) that provides a basis for fine-tuning a conditioning neural network model, such as a 3D ControlNet model, that is used to control and/or enhance the pre-trained model, which is then further trained with additional input data. In some embodiments, fine-tuning comprises training a variant or modified instance of the pre-trained model on a relatively smaller set of paired normal-dose and low-dose (e.g., high-quality and low-quality, respectively) PET images. As disclosed herewith, the variant or modified instance of the pre-trained model may comprise a 3D ControlNet model that incorporates a trainable copy of the pre-trained model (e.g., comprising 3D UNet blocks) and additional zero-convolution layers for conditioning. By fine-tuning using a small set of paired low-dose and normal-dose PET images, limitations of existing diffusion-based denoising methods, which may struggle with adaptability to different acquisition protocols and overfitting with limited training data, may be solved.

The conditioning neural network model may be used to incorporate low-dose PET images into the pre-trained model, enabling the 3D DDPM to generate corresponding normal-dose PET images rather than random samples. By freezing the parameters of the pre-trained model and creating trainable copies of its input layer 602A, encoder blocks 604A, and/or middle block 606A, the conditioning neural network model may preserve the quality and functionality of the pre-trained model.

The input layer trainable copy 602B, the encoder block training copy 604B, the middle block training copy 606B, and the pre-trained model are connected via zero convolution layers 620, 622, and 624 (e.g., 1×1 convolutions with weights and biases initialized to zero, denoted as [symbol] (⋅;⋅), which may prevent the fine-tuning process from disruptive interference). Specifically, in the pre-trained model, xₜ is first fed into the input layer [symbol] _{I}(⋅; Θ_{I}) with parameters Θ_{I}, and then passed through the encoder blocks [symbol] _{E}(⋅; Θ_{E}) with parameters Θ_{E} to obtain the feature map fₜ, which may be represented by:

$${f}_{t} = {ℱ}_{E} ( {ℱ}_{I} ( {x}_{t} ; {Θ}_{I} ) ; {Θ}_{E} ) . \qquad Equation 5$$

Then, fₜ is processed by the decoder blocks 608 and output layer 610 to produce the estimated denoised image xₜ₋₁. During fine-tuning, the parameters of the pre-trained model may be frozen, and the input layer 602A and the encoder blocks 604A of the pre-trained model may be cloned into the input layer trainable copy 602B and the encoder block training copy 604B, respectively, with parameters Θ_{IC} and Θ_{EC}.

The input layer trainable copy 602B receives y as input, which is passed through the input layer trainable copy 602B and a first zero convolution layer [symbol] ₁(⋅; Θ_{z1}) 620, with trainable parameters Θ_{z1}. Output from the first zero convolution layer [symbol] ₁(⋅; Θ_{z1}) 620 may be added with features from xₜ₋₁ to obtain an intermediate feature map m_{tc}, which may be represented by:

$${m}_{tc} = {𝒵}_{1} ( {ℱ}_{I} ( y ; {Θ}_{IC} ) ; {Θ}_{z 1} ) + {ℱ}_{I} ( {x}_{t} ; {Θ}_{I} ) , \qquad Equation 6$$

which may be fed into the encoder block training copy 604B, followed by a second zero convolution layer [symbol] ₂(⋅; Θ_{z2}) 622 with trainable parameters Θ_{z2}. The output from the second zero convolution layer [symbol] ₂(⋅; Θ_{z2}) 622 may be added to the feature map fₜ from the pre-trained model to obtain a controlled feature map f_{tc}, which may be represented by:

$${f}_{tc} = {𝒵}_{2} ( {ℱ}_{E} ( {m}_{tc} ; {Θ}_{EC} ) ; {Θ}_{z 2} ) + {f}_{t} . \qquad Equation 7$$

An estimated denoised image xₜ₋₁ may be generated by feeding f_{tc} into the frozen decoder blocks 608 and output layer 610, in which the outputs from the trainable copies of the conditional neural network may be skip-connected to the decoder blocks 608 via zero convolution layers 624.

Example Reverse Diffusion with Low-Dose Conditioning

Reverse diffusion with low-dose conditioning may starts from Gaussian noise x_{T}~ [symbol] (0,I) and iteratively predicts xₜ₋₁ from xₜ. Given a low-dose PET image y (used as a condition), A DDPM may learn a parameterized reverse transition,

$${p}_{θ} ( {x}_{t - 1} \vert {x}_{t} , y ) = 𝒩 ( {x}_{t - 1} ; {μ}_{θ} ( {x}_{t} , y , t ) , {σ}_{t}^{2} I ) \qquad Equation 8$$

where

$${σ}_{t}^{2}$$

may be fixed. The model may be trained to predict the forward noise ∈ using a UNet backbone, denoted as, ∈_{θ}(xₜ, y, t) which may yield the objective:

$${ℒ}_{DDPM} ( θ ) = {𝔼}_{{x}_{0} , y , t , ϵ} [ {‖ ϵ - {ϵ}_{θ} ( {x}_{t} , y , t ) ‖}_{2}^{2} ] \qquad Equation 9$$

At inference, the denoising update may be expressed as,

$$Equation 10$$

$${x}_{t - 1} = \frac{1}{\sqrt{{α}_{t}}} ( {x}_{t} - \frac{{β}_{t}}{\sqrt{1 - {\overline{α}}_{t}}} {ϵ}_{θ} ( {x}_{t} , y , t ) ) + {σ}_{t} z , where z \sim 𝒩 ( 0 , I ) .$$

The resulting conditional DDPM may be used to provide a baseline where the conditioning may be enriched by explicitly modeling dose level and anatomical context, enabling the DDPM to adapt across heterogeneous acquisitions and body regions.

### Example Dose- and Anatomy-Adaptive PET Image Denoising Training Framework

Whole-body PET image denoising may be intrinsically heterogeneous considering that noise levels may vary substantially across dose/count settings, and/or that anatomical regions may exhibit different uptake patterns and structures that demand region-aware priors. To address such challenges, a dose- and anatomy-adaptive denoising training framework may be provided that injects dose semantics and anatomy semantics into a conditional DDPM.

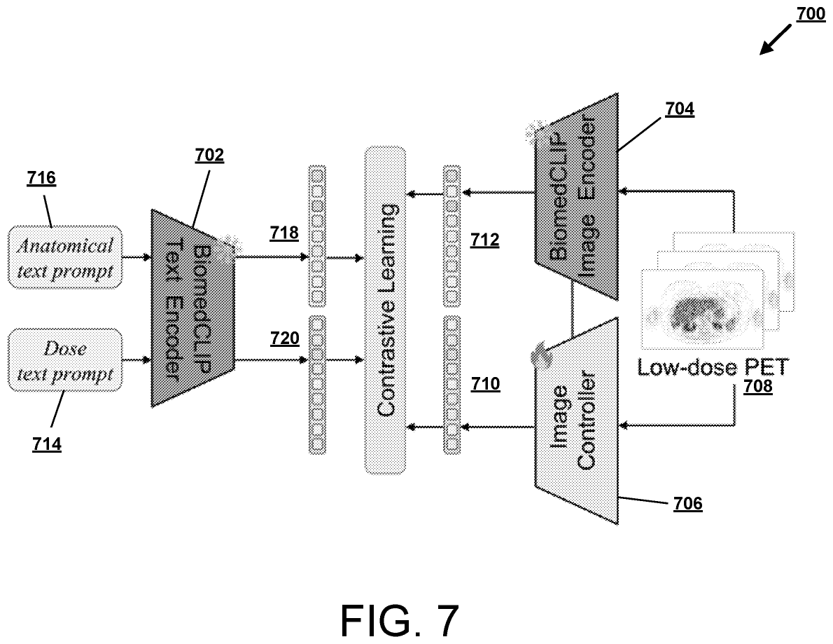

FIG. 7 is a dataflow diagram of an example first training stage 700 of a dose- and anatomy-aware DDPM PET denoising framework in accordance with some embodiments of the present disclosure. A text-guided PET image denoising training dataset that integrates dose and anatomical information may be provided to the first training stage 700. For example, the text-guided PET image denoising training dataset may comprise paired 1/20 low-dose, 1/50 low-dose, and normal-dose PET images together with corresponding dose and anatomical descriptions in the form of text prompts for each axial slice.

The first training stage 700 may comprise a pretrained VLM (e.g., BiomedCLIP) that is adapted for PET image processing. Given a low-dose PET image y 708, the first training stage 700 may produce a dose embedding (c^{dose}∈ [symbol] ^{M×d}) 710 and an anatomy embedding sequence (C^{anat}∈ [symbol] ^{M×d}) 712 that semantically correspond to dose-level and anatomical text prompts, respectively.

A low-dose PET image y 708 may be described by multiple valid texts—a dose text prompt 714 (e.g., “5% of the total counts”) and an anatomical text prompt 716 capturing the organs/structures present in a slice (e.g., “axial slice including liver, spleen, stomach, . . . ”). Moreover, there may be multiple textual variants per category (e.g., synonyms, different granularity, or template-based prompts). As such, many-to-one (or multi-positive) relationships may exist between the low-dose PET image y 708 and text. According to various embodiments of the present disclosure, the first training stage 700 may jointly align each image with all associated positive texts.

A pretrained VLM may comprise a text encoder (Eₜₑₓₜ(⋅)) 702 and an image encoder (E_{img}(⋅)) 704. The text encoder 702 and the image encoder 704 may be frozen and integrated with an image controller 706 comprising a PET-adaptation module that refines image representations for PET while preserving the pretrained language space. For a low-dose PET image y 708 of a set of one or more training images, the image controller 706 may produce two image-side embeddings,

$${v}^{dose} = {E}_{dose} ( y ) ∈ {ℝ}^{d} , \qquad Equation 11$$

$${v}^{anat} = {E}_{anat} ( y ) ∈ {ℝ}^{d} , \qquad Equation 12$$

where d=512, for example. For a pair of dose and anatomical text prompts (e.g., dose text prompt 714 and anatomical text prompt 716), the following normalized text embeddings (e.g., dose text embedding 718 and anatomy text embedding 720) may be obtained:

$$\begin{matrix}{t}_{k}^{d o s e} = \frac{{E}_{t e x t} ( {τ}_{k}^{d o s e} )}{{‖ {E}_{t e x t} ( {τ}_{k}^{d o s e} ) ‖}_{2}} & k = 1 , … , K ,\end{matrix} \qquad Equation 13$$

$$\begin{matrix}{t}_{m}^{a n a t} = \frac{{E}_{t e x t} ( {τ}_{m}^{a n a t} )}{{‖ {E}_{t e x t} ( {τ}_{m}^{a n a t} ) ‖}_{2}} & m = 1 , … , M ,\end{matrix} \qquad Equation 14$$

where

$${\{ {τ}_{k}^{d o s e} \}}_{k = 1}^{K}$$

may comprise a set of one or more dose text prompts, including the dose text prompt 714, and

$${\{ {t}_{m}^{a n a t} \}}_{m = 1}^{M}$$

may comprise a set of one or more anatomical text prompts, including the anatomical text prompt 716, that are associated with the low-dose PET image y 708. The image embeddings, v^{dose} and v^{anat} may be [symbol] ₂ normalized.

For a subset B of the set of one or more training images and for the i-th image, [symbol] ^{dose}(i) may denote the index set of its positive dose text prompts in a text set corresponding to the set of one or more training images, and similarly [symbol] ^{anat}(i) for anatomical text prompts. Cosine similarity may be defined as s(a, b)=a^{T}b (after normalization) and a temperature γ>0. A multi-positive dose image-to-text loss may be expressed as,

$${ℒ}_{I \to T}^{dose} = - \frac{1}{B} {\sum }_{i = 1}^{B} log \frac{{Σ}_{j ∈ {𝒫}^{dose} ( i )} exp ( s ( {v}_{i}^{dose} , {t}_{j}^{dose} ) / γ}{{Σ}_{j = 1}^{{N}_{dose}} exp ( s ( {v}_{i}^{dose} , {t}_{j}^{dose} ) / γ} \qquad Equation 15$$

where N_{dose} may comprise the number of dose-text embeddings participating in the denominator (e.g., all dose texts in the text set). A symmetric dose text-to-image loss may be expressed as,

$${ℒ}_{T \to I}^{d o s e} = - \frac{1}{{N}_{d o s e}} {\sum }_{j = 1}^{{N}_{d o s e}} log \frac{{Σ}_{i ∈ {Q}^{d o s e} ( j )} exp ( s ( {t}_{j}^{d o s e} , {v}_{i}^{d o s e} ) / γ}{{Σ}_{i = 1}^{B} exp ( s ( {t}_{j}^{d o s e} , {v}_{i}^{d o s e} ) / γ} \qquad Equation 16$$

where Q^{dose}(j) may denote the set of one or more training images for which text j is a positive. An anatomy image-to-text loss

$${ℒ}_{I \to T}^{a n a t}$$

and an anatomy text-to-image loss

$${ℒ}_{T \to I}^{a n a t}$$

may be analogously defined using (v^{anat}, t^{anat}).

Accordingly, a first training stage objective may be,

$${ℒ}_{S t a g e 1} = {λ}_{d o s e} ( {ℒ}_{I \to T}^{d o s e} + {ℒ}_{T \to I}^{d o s e} ) + {λ}_{a n a t} ( {ℒ}_{I \to T}^{a n a t} + {ℒ}_{T \to I}^{a n a t} ) \qquad Equation 17$$

where λ_{dose} and λₐₙₐₜ balance the two semantic factors.

After performing a first training stage (e.g., using the first training stage 700), given a low-dose PET image y 708, the following may be extracted:

$$\begin{matrix}{c}^{dose} = {v}^{dose} ∈ ℝ , & {c}^{anat} ∈ {ℝ}^{d} ,\end{matrix} \qquad Equation 18$$

where C^{anat} may be produced based on token-level image features provided from the image encoder 704 (e.g., patch tokens). Then, the C^{anat} may be projected to a dimension d, which is explained in further detail with respect to a description of a second training stage. Intuitively, c^{dose} may provide a compact global descriptor of noise statistics, while C^{anat} may provide a set of localized semantic tokens that encode anatomy-relevant cues.

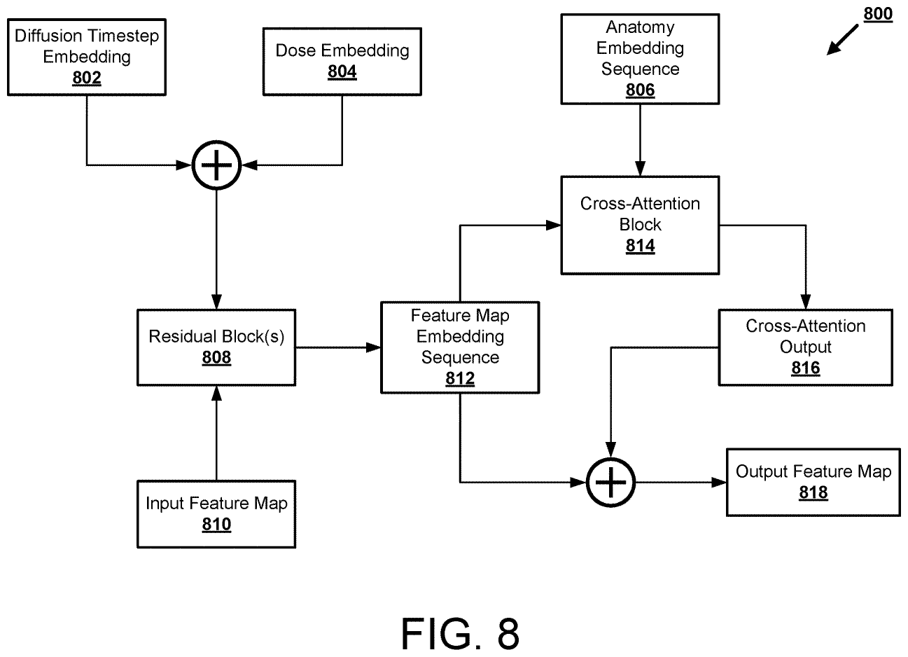

FIG. 8 is a dataflow diagram of an example second training stage 800 of a dose- and anatomy-aware DDPM PET denoising framework in accordance with some embodiments of the present disclosure. The second training stage 800 may integrate dose embedding 804 (c^{dose}) into a diffusion timestep embedding 804 via prompt learning, and integrate an anatomy embedding sequence 806 (C^{anat}) into an input feature map 810 via a cross-attention block 814. As such, a DDPM may be trained end-to-end to denoise conditioned on y, c^{dose}, and C^{anat}. At inference time, both dose and anatomy priors may be extracted directly from an input low-dose PET image, without external metadata or paired CT images.

The conditional DDPM in Equation 10 may be extended by conditioning on dose and anatomy priors,

$${ϵ}_{θ} ( {x}_{t} , y , t , {c}^{d o s e} , {c}^{a n a t} ) . \qquad Equation 19$$

The diffusion loss may become,

$${ℒ}_{S t a g e 2} ( θ ) = {𝔼}_{{x}_{0} , y , t , ϵ} [ {‖ ϵ - {ϵ}_{θ} ( {x}_{t} , y , t , {c}^{d o s e} , {C}^{a n a t} ) ‖}_{2}^{2} ] . \qquad Equation 20$$

A DDPM may comprise a diffusion timestep embedding (eₜ∈ [symbol] ^{d}^{ₜ}) 802 (e.g., a sinusoidal embedding followed by a multi-layer perceptron (MLP)) that conditions an underlying neural network (e.g., UNet) of the DDPM on diffusion step t. However, dose level may strongly affect noise amplitude and spatial appearance. Accordingly, dose semantics may be inserted directly into the timestep pathway to modulate denoising dynamics.

Given eₜ=MLPₜ(PE(t))∈ [symbol] ^{d}^{ₜ} as the diffusion time embedding 802, the dose embedding 804 is mapped into a same embedding space as the diffusion time embedding 802 by using an MLP and learning a dose-conditioned text prompt,

$${p}^{dose} = {MLP}_{dose} ( {c}^{dose} ) ∈ {ℝ}^{{d}_{t}} \qquad Equation 21$$

$${\tilde{e}}_{t} = {e}_{t} + {p}^{dose} \qquad Equation 22$$

The modified timestep embedding \tilde{e}ₜ may then be used throughout one or more residual blocks 808 of the neural network (via scale-shift or additive conditioning, consistent with the baseline implementation) to enable the DDPM to adapt its denoising strength and progression to an inferred dose level, while keeping the image-level conditioning of low-dose PET image y unchanged.

However, global conditioning alone may be insufficient for whole-body PET images because different organs and regions require different priors.

As such, anatomical information may be integrated at one or more neural networks (e.g., UNet) resolutions using cross-attention between neural network (e.g., UNet) feature maps, such as input feature map 810, and anatomy tokens via anatomy embedding sequence 806.

With H∈ [symbol] ^{C×H×W} representing an intermediate feature map provided by a residual block at a given resolution of the one or more residual blocks 808, the intermediate feature map may be flattened into a feature map embedding sequence 812 (X∈ [symbol] ^{N∈C}) with N=HW. C^{anat}∈ [symbol] ^{M×d} may be treated as context tokens (e.g., from first training stage). A cross-attention block 814 generates a cross-attention output 816 based on a query Q, a key K, and a value V. The query Q may be determined by based on the feature map embedding sequence 812 and a query learnable projection W_{Q}. The key K may be determined based on the anatomy embedding sequence 806 and a key learnable projection W_{K}. The value V may be determined based on the anatomy embedding sequence 806 and a value learnable projection W_{V}. For example,

$$\begin{matrix}\begin{matrix}Q = {XW}_{Q} , & K = {C}^{anat} {W}_{k} , & V = {C}^{anat} {W}_{v}\end{matrix} & Equation 23 \\ Attn ( X , {C}^{anat} ) = soft max ( \frac{{QK}^{T}}{\sqrt{{d}_{h}}} ) V & Equation 24\end{matrix}$$

where dₕ may represent the per-head dimension. The cross-attention output 816 is projected back and reshaped with the feature map embedding sequence 812 to form an output feature map 818 with a residual connection,

$$\begin{matrix}{X}^{′} = X + {W}_{O} A t t n ( X , {C}^{a n a t} ) , & {H}^{′} = r e s h a p e ( {X}^{′} ) .\end{matrix} \qquad Equation 25$$

The cross-attention block 814 (e.g., implemented as spatial transformers) may be inserted at selected UNet resolutions so that anatomy tokens may guide denoising both at coarse and fine scales. By doing so, the DDPM may be encouraged to allocate capacity to anatomy-relevant structures and improve region-specific recovery.

The image encoder 704 from the first training stage 700 may output the anatomy embedding sequence 712 in the form of a sequence of patch tokens (and a class token) that are used as anatomy context because they preserve spatially localized semantics. Specifically, given a low-dose PET image y, the image encoder 704 provides patch tokens T∈ [symbol] ^{M×D}^{ᵥ}, which may be optionally down-sampled in token space (to reduce compute) and then projected to d (e.g., =512) giving,

$${C}^{a n a t} = T {W}_{proj} ∈ {ℝ}^{M \times d} . \qquad Equation 26$$

M may be configured by the tokenization of the image encoder 704 (e.g., M=197 for ViT-B/16 with 14×14 patches, or reduced to M=50 via 2×2 pooling over patch tokens), and Wₚᵣₒⱼ may represent a learnable linear layer.

Accordingly, training provided by the first training stage 700 and the second training stage 800 allows at inference, given an original low-dose PET image, extraction of dose and anatomy priors to perform iterative denoising, yielding a normal-dose-quality reconstruction (e.g., comprising a higher quality than the original low-dose PET image). By doing so, a single DDPM may generalize across multiple dose levels and diverse anatomical regions without external metadata or CT guidance.

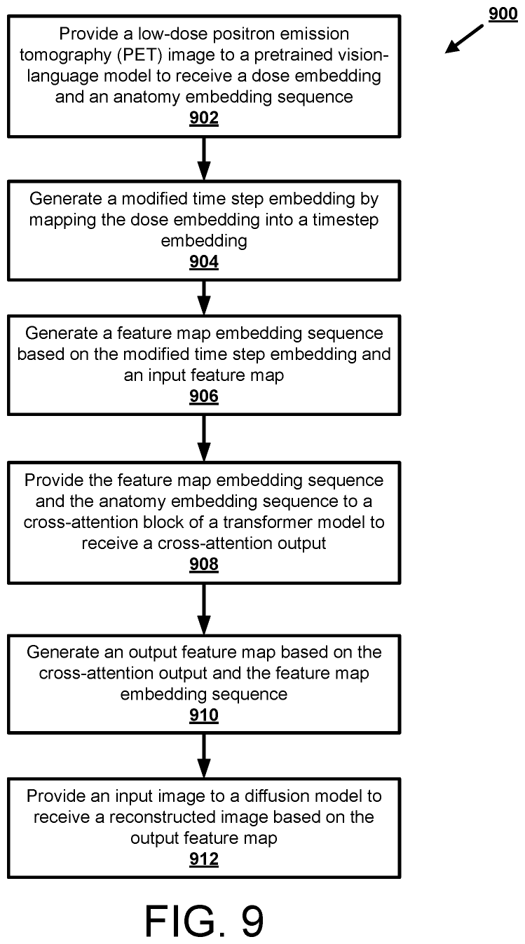

FIG. 9 is a flowchart of an example process 900 for denoising low-dose PET images according to some embodiments of the present disclosure.

In some embodiments, the process 900 begins at step/operation 902 when the computing system 101 provides a low-dose positron emission tomography (PET) image to a pretrained vision-language model to receive a dose embedding and an anatomy embedding sequence, wherein the dose embedding semantically corresponds to a dose text prompt and the anatomy embedding sequence semantically corresponds to an anatomical text prompt.

In some embodiments, at step/operation 904, the computing system 101 generates a modified time step embedding by mapping the dose embedding into a timestep embedding.

In some embodiments, at step/operation 906, the computing system 101 generates a feature map embedding sequence based on the modified time step embedding and an input feature map.

In some embodiments, at step/operation 908, the computing system 101 provides the feature map embedding sequence and the anatomy embedding sequence to a cross-attention block of a transformer model to receive a cross-attention output.

In some embodiments, at step/operation 910, the computing system 101 generates an output feature map based on the cross-attention output and the feature map embedding sequence.

In some embodiments, at step/operation 912, the computing system 101 provides an input image to a diffusion model to receive a reconstructed image based on the output feature map.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

What is claimed is:

1. A computer-implemented method comprising:
providing, by one or more processors, a low-dose positron emission tomography (PET) image to a pretrained vision-language model to receive a dose embedding and an anatomy embedding sequence, wherein the dose embedding semantically corresponds to a dose text prompt and the anatomy embedding sequence semantically corresponds to an anatomical text prompt;
generating, by the one or more processors, a modified time step embedding by mapping the dose embedding into a timestep embedding;
generating, by the one or more processors, a feature map embedding sequence based on the modified time step embedding and an input feature map;
providing, by the one or more processors, the feature map embedding sequence and the anatomy embedding sequence to a cross-attention block of a transformer model to receive a cross-attention output;
generating, by the one or more processors, an output feature map based on the cross-attention output and the feature map embedding sequence; and
providing, by the one or more processors, an input image to a diffusion model to receive a reconstructed image based on the output feature map.

2. The computer-implemented method of claim 1 further comprising:
determining, using the cross-attention block, a query based on the feature map embedding sequence and a query learnable projection;
determining, using the cross-attention block, a value based on the anatomy embedding sequence and a value learnable projection; and
determining, using the cross-attention block, a key based on the anatomy embedding sequence and a key learnable projection.

3. The computer-implemented method of claim 1, wherein the cross-attention block is inserted at a neural network resolution of the diffusion model.

4. The computer-implemented method of claim 1 further comprising:
providing a set of one or more training images, including the low-dose PET image, to an image controller to receive a dose image embedding;
providing the set of one or more training images, including the low-dose PET image, to an image encoder of the pretrained vision-language model to receive an anatomy image embedding;
providing the dose text prompt to a text encoder of the pretrained vision-language model to receive a dose text embedding; and
providing the anatomical text prompt to the text encoder of the pretrained vision-language model to receive an anatomy text embedding.

5. The computer-implemented method of claim 4 further comprising:
generating a dose image-to-text loss or a dose text-to-image loss based on a first cosine similarity value between the dose image embedding and the dose text embedding; and
generating an anatomy image-to-text loss or an anatomy text-to-image loss based on a second cosine similarity value between the anatomy image embedding and the anatomy text embedding.

6. The computer-implemented method of claim 4, wherein generating the modified time step embedding further comprises:
generating a dose-conditioned text prompt based on the dose image embedding; and
modifying the timestep embedding based on the dose-conditioned text prompt.

7. The computer-implemented method of claim 1, wherein the dose text prompt and the anatomical text prompt are associated with the low-dose PET image.

8. The computer-implemented method of claim 1, wherein the timestep embedding corresponds to a conditional denoising diffusion probabilistic model (DDPM).

9. The computer-implemented method of claim 1 further comprising:
storing the output feature map in association with a neural network of the diffusion model; and
generating, using the neural network, the reconstructed image.

10. The computer-implemented method of claim 1, wherein
(i) the diffusion model is configured to perform iterative denoising on the input image based on the output feature map,
(ii) the diffusion model is trained on a dataset comprising a plurality of paired normal-dose and low-dose PET images,
(iii) a normal-dose image of the plurality of paired normal-dose and low-dose PET images comprises a desired image quality, and
(iv) a low-dose PET image of the plurality of paired normal-dose and low-dose PET images comprises a low image quality that is lower than the desired image quality.

11. A system comprising
one or more processors and
one or more non-transitory computer readable media storing processor-executable instructions that, when executed by the one or more processors, cause the one or more processors to perform operations comprising:
providing a low-dose positron emission tomography (PET) image to a pretrained vision-language model to receive a dose embedding and an anatomy embedding sequence, wherein the dose embedding semantically corresponds to a dose text prompt and the anatomy embedding sequence semantically corresponds to an anatomical text prompt;
generating a modified time step embedding by mapping the dose embedding into a timestep embedding;
generating a feature map embedding sequence based on the modified time step embedding and an input feature map;
providing the feature map embedding sequence and the anatomy embedding sequence to a cross-attention block of a transformer model to receive a cross-attention output;
generating an output feature map based on the cross-attention output and the feature map embedding sequence; and
providing an input image to a diffusion model to receive a reconstructed image based on the output feature map.

12. The system of claim 11, wherein the operations further comprise:
determining, using the cross-attention block, a query based on the feature map embedding sequence and a query learnable projection;
determining, using the cross-attention block, a value based on the anatomy embedding sequence and a value learnable projection; and
determining, using the cross-attention block, a key based on the anatomy embedding sequence and a key learnable projection.

13. The system of claim 11, wherein the cross-attention block is inserted at a neural network resolution of the diffusion model.

14. The system of claim 11, wherein the operations further comprise:
providing a set of one or more training images, including the low-dose PET image, to an image controller to receive a dose image embedding;
providing the set of one or more training images, including the low-dose PET image, to an image encoder of the pretrained vision-language model to receive an anatomy image embedding;
providing the dose text prompt to a text encoder of the pretrained vision-language model to receive a dose text embedding; and
providing the anatomical text prompt to the text encoder of the pretrained vision-language model to receive an anatomy text embedding.

15. The system of claim 14, wherein the operations further comprise:
generating a dose image-to-text loss or a dose text-to-image loss based on a first cosine similarity value between the dose image embedding and the dose text embedding; and
generating an anatomy image-to-text loss or an anatomy text-to-image loss based on a second cosine similarity value between the anatomy image embedding and the anatomy text embedding.

16. The system of claim 14, wherein generating the modified time step embedding further comprises:
generating a dose-conditioned text prompt based on the dose image embedding; and
modifying the timestep embedding based on the dose-conditioned text prompt.

17. The system of claim 11, wherein the dose text prompt and the anatomical text prompt are associated with the low-dose PET image.

18. The system of claim 11, wherein the timestep embedding corresponds to a conditional denoising diffusion probabilistic model (DDPM).

19. The system of claim 11, wherein the operations further comprise:
storing the output feature map in association with a neural network of the diffusion model; and
generating, using the neural network, the reconstructed image.

20. One or more non-transitory computer-readable storage media storing instructions that, when executed by one or more processors, cause the one or more processors to perform operations comprising:
providing a low-dose positron emission tomography (PET) image to a pretrained vision-language model to receive a dose embedding and an anatomy embedding sequence, wherein the dose embedding semantically corresponds to a dose text prompt and the anatomy embedding sequence semantically corresponds to an anatomical text prompt;
generating a modified time step embedding by mapping the dose embedding into a timestep embedding;
generating a feature map embedding sequence based on the modified time step embedding and an input feature map;
providing the feature map embedding sequence and the anatomy embedding sequence to a cross-attention block of a transformer model to receive a cross-attention output;
generating an output feature map based on the cross-attention output and the feature map embedding sequence; and
providing an input image to a diffusion model to receive a reconstructed image based on the output feature map.
